(19) United States
(12) Patent Application Publication
(10) Pub. No.: US 2014/0236182 A1
(43) Pub. Date: Aug. 21, 2014

(54) Device and Method For Removing Unwanted Hair

(71) Applicant: Susan Lyda Reynolds, Denver, CO (US)

(72) Inventor: Susan Lyda Reynolds, Denver, CO (US)

(21) Appl. No.: 13/769,294

(22) Filed: Feb. 16, 2013

(51) Int. Cl. A45D 26/00; H05B 1/00

(52) U.S. Cl. CPC A45D 26/0014; H05B 1/00
USPC 606/134; 606/133; 219/201

(57) ABSTRACT

A device for removing unwanted hair includes a housing having a first end and a second end. The first end holds a depilatory product and has a cylindrical shape with a circular opening. A second end has a conical shape with a shaped opening. A plunger fits in the circular opening and mates with the cylindrical shape of the first end of the housing. The housing is made of a rigid polymer and is a microwave safe material.

A method of removing unwanted hair includes the steps of heating a syringe containing a wax until the wax is in a liquid state. A tip of the syringe is placed next to an area of hair to be removed. The wax is applied to the area of hair. Then the wax is manually removed when in solid form or by applying fabric/paper strips.

### RELATED APPLICATIONS

The present invention claims priority on provisional patent application, Ser. No. 61/601091, filed on Feb. 21, 2012, entitled “Depilatory Wax Syringe” and is hereby incorporated by reference.

### STATEMENT REGARDING FEDERALLY SPONSORED RESEARCH

Not Applicable

### THE NAMES OF THE PARTIES TO A JOINT RESEARCH AGREEMENT

Not Applicable

### REFERENCE TO A SEQUENCE LISTING, A TABLE, OR A COMPUTER PROGRAM LISTING

Not Applicable

### BACKGROUND OF THE INVENTION

People often have unwanted hair, such as hair on their legs, faces, backs, etc. Razors have been common device for removing unwanted hair. Razors usually require the person to shave every day. Waxing has become more common in recent times. It is more effective in removing hair and usually lasts for a week or longer. The prevailing method of depilatory and epilatory wax implementation/application is antiquated, unsanitary/unsafe and inaccurate. This method most commonly involves the manual manipulation of a wooden spatula into a communal vat of melted wax or other depilatory product, which is then guided to the intended area, with varying degrees of accuracy/success.

There is a need for an alternative which is sanitary, safe, disposable, easily transported, agile, manageable and universal for in-home and professional salon/spa use. Note as used herein depilatory cover epilatory and all physical hair removal techniques.

### BRIEF SUMMARY OF INVENTION

A device for removing unwanted hair that overcomes these and other problems includes a housing having a first end and a second end. The first end holds a depilatory product and has a cylindrical shape with a circular opening. A second end has a conical shape with a shaped opening. A plunger fits in the circular opening and mates with the cylindrical shape of the first end of the housing. The housing is made of a rigid polymer and is a microwave safe material.

A method of removing unwanted hair includes the steps of heating a syringe containing a wax until the wax is in a liquid state. A tip of the syringe is placed on an area of hair to be removed. The wax is applied to the area of hair. Then the wax is manually removed when in solid form or by applying fabric/paper strips.

Using this process and device is sanitary, safe, disposable, easily transported, agile, manageable and universal, for in-home and professional salon/spa use.

### BRIEF DESCRIPTION OF THE SEVERAL VIEWS OF THE DRAWINGS

FIG. 1 is a side view of a device for removing hair in accordance with one embodiment of the invention;

FIG. 2 is a shaped opening of a device for removing hair in accordance with one embodiment of the invention;

FIG. 3 is a shaped opening of a device for removing hair in accordance with one embodiment of the invention; and

FIG. 4 is a flow chart of the steps in a method of removing hair in accordance with one embodiment of the invention.

### DETAILED DESCRIPTION OF THE INVENTION

A device for removing unwanted hair includes a housing having a first end and a second end. The first end holds a depilatory product and has a cylindrical shape with a circular opening. A second end has a conical shape with a shaped opening. A plunger fits in the circular opening and mates with the cylindrical shape of the first end of the housing. The housing is made of a rigid polymer that is a microwave safe material.

A method of removing unwanted hair includes the steps of heating a syringe containing a wax until the wax is in a liquid state. A tip of the syringe is placed on an area of hair to be removed. The wax is applied to the area of hair. Then the wax is manually removed when in solid form or by applying fabric/paper strips.

Using this process and device is sanitary, safe, disposable, easily transported, agile, manageable and universal, for in-home and professional salon/spa use.

FIG. 1 is a side view of a device 10 for removing hair in accordance with one embodiment of the invention. The device has a housing 12 with a first end 14 and a second end 16. The first end 14 of the housing 12 holds a depilatory product 18. The second end of the housing has a shaped opening 20. In one embodiment, the device includes a plunger 22. The plunger 22 fits into an opening 24 in the first end 14 of the housing 12. The plunger 22 may include a rubber gasket 26. In one embodiment, the depilatory product is a wax or a paraffin wax. The depilatory product may be a hot wax, cold wax, sugaring, etc. In one embodiment, a cap 28 fits over the opening 24 for shipping and is removed when the device is used. In another embodiment, the plunger 22 acts as a cap. In one embodiment, the device 10 has a heater 30 shown with an electrical cord 32. The heater 30 fits around the housing 12. In one embodiment, the housing 12 is made of a rigid polymer that is microwave safe. In another embodiment, the first end of the housing is cylindrical and the second end of the housing is conical. Note that the device can be immersed in a hot water bath to melt the wax as well. In one embodiment there may be a cap over the shaped opening 20.

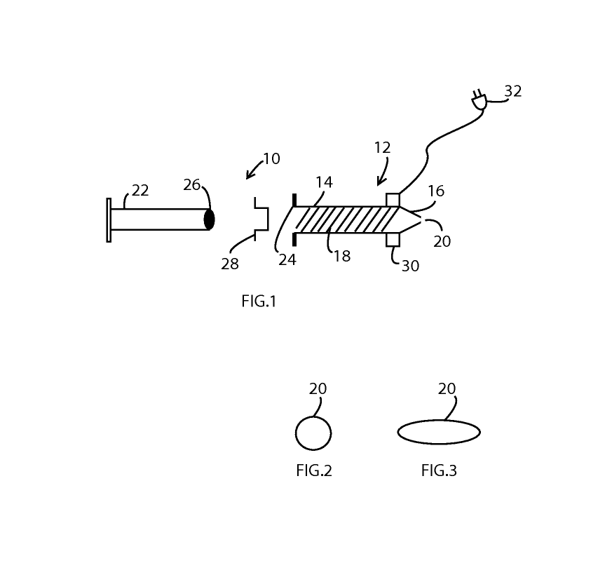

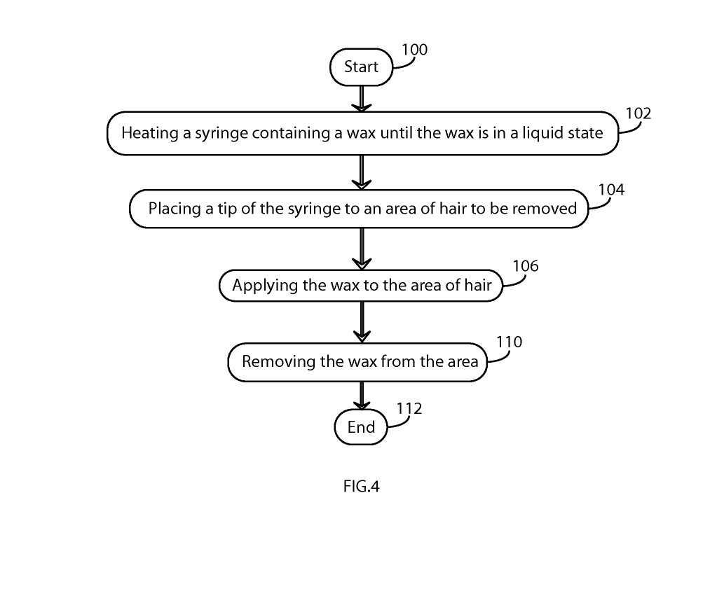

FIG. 2 is a shaped opening 20 of a device for removing hair in accordance with one embodiment of the invention. This figure shows that the shaped opening 20 has a circular cross section. FIG. 3 shows the shaped opening that is more elliptical or elongated.

FIG. 4 is a flow chart of the steps in a method of removing hair in accordance with one embodiment of the invention. The process starts, step 100, by heating a housing containing wax until the wax is in a liquid state at step 102. The tip of the syringe is placed on the area of hair to be removed at step 104. The wax is applied to the area of hair at step 106. Then the wax is manually removed when in solid form or by applying fabric/paper strips at step 110, which ends the process at step 112. Thus there has been described a device and method for removing hair that is sanitary, safe, disposable, easily transported, agile, manageable and universal, for in-home and professional salon/spa use.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A device for removing unwanted hair, comprising:
a housing having a first end and a second end,
the first end of the housing holding a depilatory product; and
the second end of the housing having a shaped opening for applying the depilatory product.

2. The device of claim 1, wherein the first end has an opening for receiving the depilatory product, wherein the shaped opening is smaller than the opening

3. The device of claim 2, further including a cap between the depilatory product and the opening.

4. The device of claim 1, wherein the depilatory product is a paraffin wax.

5. The device of claim 3, further including a plunger attached to the cap.

6. The device of claim 1, wherein the shaped opening is a round nozzle.

7. The device of claim 1, wherein the shaped opening is elongated along one axis.

8. The device of claim 1, wherein the housing has a cylindrical section and a nozzle section.

9. The device of claim 1, further including a warmer attached to the housing.

10. The device of claim 9, wherein the warmer is an electrical heating device.

11. The device of claim 1, wherein the housing is made of a rigid polymer.

12. The device of claim 1, wherein the housing is made of a microwave safe material.

13. The device of claim 1, wherein the housing is made of a flexible material.

14. A method of removing unwanted hair, comprising the steps of:
heating a syringe containing a wax until the wax is in a liquid state;
placing a tip of the syringe to an area of hair to be removed;
applying the wax to the area of hair; and
removing the wax from the area.

15. The method of claim 14 wherein the step of heating includes the step of placing syringe in a microware.

16. The method of claim 14, wherein the step of heating includes the step of filling the syringe with the wax.

17. The method of claim 14 wherein the step of heating includes the step of placing syringe in a hot water bath.

18. A device for removing unwanted hair, comprising:
a housing having a first end and a second end, the first end holding a depilatory product, the first end having a cylindrical shape with a circular opening, a second end having a conical shape, with a shaped opening;
a plunger fitting in the circular opening and mating with the cylindrical shape of the first end of the housing;
wherein the housing is made of a rigid polymer;
wherein the housing is a microwave safe material.

19. The device of claim 18, wherein the depilatory product is a paraffin wax.

20. The device of claim 18, wherein the shaped opening does not have a circular cross section.
